(19) United States
(12) Patent Application Publication
(10) Pub. No.: US 2005/0155228 A1
(43) Pub. Date: Jul. 21, 2005

(54) PEELER COVER FOR KITCHEN KNIFE BLADE

(76) Inventor: Feng-Hsia Kuan Huo, Chung Ho City (TW)

Correspondence Address: Leong C. Lei;PMB#1008, 1867 Ygnacio Valley Rd., Walnut Creek, CA, 94598, US

(21) Appl. No.: 10/759,120

(22) Filed: Jan. 20, 2004

(51) Int. Cl. B26B 13/00

(52) U.S. Cl. 30/282; 30/280; 30/294

(57) ABSTRACT

A peeler cover for a kitchen knife comprised of a cover body and a protection clamp; the protection clamp is removed for the cover to forthwith function as a peeler by taking advantage of the spacing between the exposed cutting edge and the finish defined by an edge of a frame provided on the middle section of the cover of the cover to peel a fruit.

### BACKGROUND OF THE INVENTION

(a) Technical Field of the Invention

The present invention is related to a peeler cover for a kitchen knife blade, and more particularly, to one that peels a fruit by taking advantage of spacing created by the cutting edge of the blade and a finish defined by an edge of a frame fixed to the cover.

(b) Description of the Prior Art

Whereas a peeler with a frame embedded in a frame is available to peel a fruit, a conventional kitchen life that does not rely upon power, easy to keep in household and convenient for outdoor purpose to cut the greens still dominates the purpose for food preparation.

However, in its use, the kitchen knife is best at piercing and cutting. When coming to peeling a fruit, it is not easy to come up with a peeled fruit or potato that will not discourage the appetite. Furthermore, for one having few chances to use a kitchen knife is vulnerable to be cut when trying to occasionally peel a fruit. Therefore, the peeler is available. However, when having a picnic, one usually brings along only a kitchen knife to use it also as a peeler since it is impossible to fetch a peeler out of nowhere.

### SUMMARY OF THE INVENTION

The primary purpose of the present invention is to provide a peeler cover for a kitchen knife blade. A peeler is very difficult to be compatible with a kitchen knife or vice versa in terms of the orientation each required to exercise the force varies drastically. To achieve the purpose, the design of the cover of a kitchen knife is changed to allow the cover to function also as a peeler in conjunction with the cutting edge of the knife.

Another purpose of the present invention is to provide a peeler cover for a kitchen knife blade adapted with a protection clamp for security of closing the knife when the peeler cover is not used for peeling.

Another purpose yet of the present invention is to provide a peeler cover for a kitchen knife that offers a safety holding of the cover when functioning as a peeler. To achieve the purpose, a frame in a length half of that of the blade is each provided at the middle section of the cover at where in relation to the blade when closed. A window is provided between the frames to merely expose the blade closed in the cover. A narrow spacing is deflected between the exposed blade and the edge of the frame closer to the blade to permit a finish slot just for peeling, and both frames extend downward facing the finish slot for the hand of the user to stay away from the blade while peeling a fruit or something else.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is an exploded view of a cover of the preferred embodiment of the present invention.

FIG. 3 is a sectional view taken from III-III in FIG. 1.

FIG. 4 is a sectional view taken from IV-IV in FIG. 1.

FIG. 5 is a sectional view taken from V-V in FIG. 1.

FIG. 6 is a perspective view of a protection clamp adapted to the cover of the preferred embodiment of the present invention.

FIG. 7 is a sectional view taken from VI-VI in FIG. 6.

FIG. 8 is a schematic view showing that a right-hander uses the preferred embodiment to peel an apple.

FIG. 9 is a schematic view showing that a left-hander uses the preferred embodiment to peel an apple.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

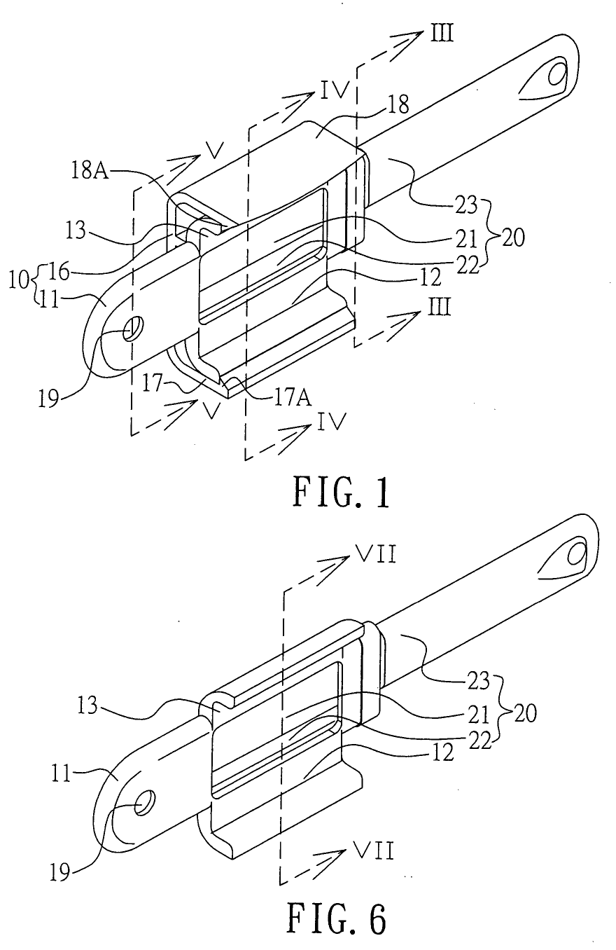

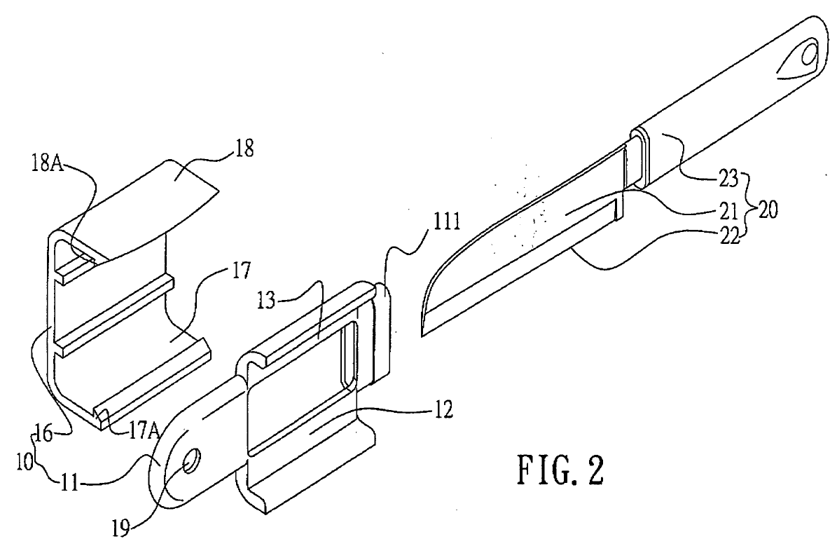

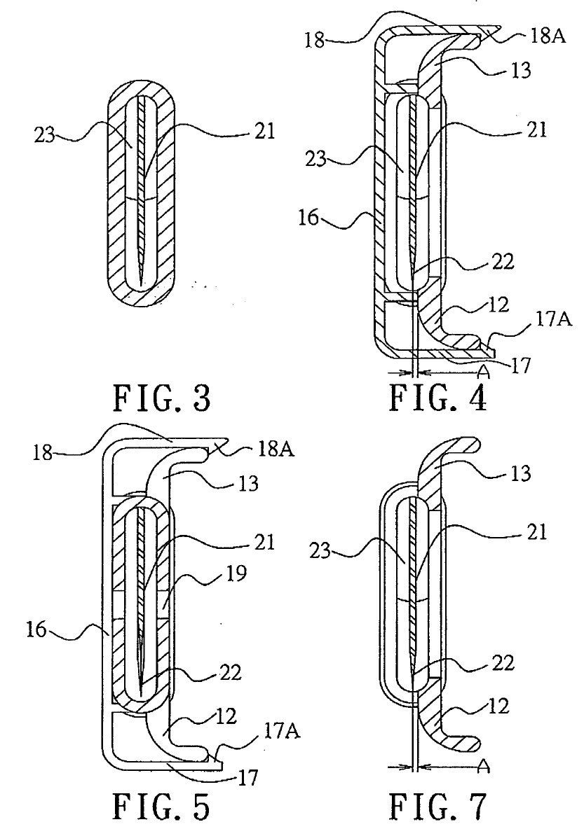

Referring to FIGS. 1 through 5, a preferred embodiment of the present invention, a peeler cover 10 for a kitchen knife 20 is essentially comprised of a body 11 and a protection clamp 16. Wherein, two frames 12, 13 each in a length half of that of a blade 21 are respectively provided on both sides of the blade 21 closed in the cover 10 at the middles section of the cover. A window is defined between both frames 12, 13 to merely expose the blade 21 closed in the cover 10. The frame 12 (or the frame 13, with the location of a handle 23 of the knife 20 unchanged, the knife 20 with its blade facing upward is closed in the cover 10) in front of the exposed blade 22 is deflected to define a finish slot A appropriately for peeling. Both frames 12, 13 extend towards another end of the finish slot A. The protection clamp 16 provided flush over the window at the middle section of the body 11 relates to a screening member given with mild restoration capacity by elasticity. Each of both wings of the protection clamp 16 extends vertically for a locking panel 17 (18) overlapped on the frame 12 (13). The distal end of the locking panel 17 (18) further extends for a locking point 17A (18A) over the edge of the frame 17 (18) for the protection clamp 16 to be locked up with the body 11 while covering up the exposed blade 22 and the finish gap A and allowing a ventilation hole 19 to be provided near the tip of the cover without compromising the covering function and strength of the cover 10.

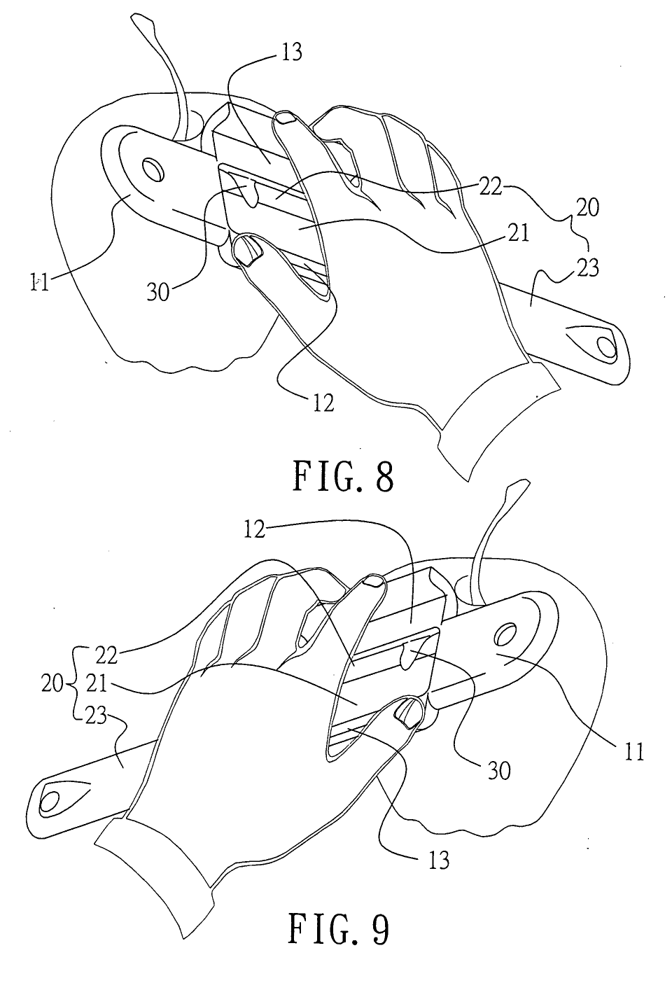

With the knife 20 inserted into the cover 10, either locking point 17A or 18A is dialed outwardly to remove the protection clamp 16 as illustrated in FIG. 6. Both frames 12, 13 with the blade 22 opened up allow the finish slot A to be exposed as illustrated in FIG. 7. With the location of a handle 23 unchanged and depending on a right-hander or a left-hander, the point of the blade is turned for 180 degrees. The knife 20 is inserted into the body 11 with the blade 21 to be located at where closer to either the frame 12 or 13 as illustrated in FIG. 8 or 9 to operate the cover 10 as the peeler by holding the handler 23 or both of the frames 12 13 towards the finish slot A extended on the other end as illustrated in FIG. 7 for an easy peeling of an apple 30. The present invention allows the knife 20 while easily providing its conventional purpose of cutting and piercing to function also as a peeler. The spacing between the inner wall of the body 10 and the blade 22 of the knife 20 is capable of maintaining proper friction resistance after many cycles of insertion and removal with a proper sealing gap to prevent easy slipping off whenever the knife carries any oil film, thus to eliminate the danger of being cut by the escaping body 10 in the worrying of holding at the place other than the handle 23.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-4. (canceled)

5. A cover for converting a kitchen knife into a peeler comprising:
a body having a holder adapted for receiving a blade of a knife, two frames at two sides of said body, and a window defined between said two frames to expose said blade, one of said frames in front of said exploded blade being deflected to define a finish slot for peeling; and
a protection clamp having an upper flange and a lower flange extending vertically to form locking panels overlapped on said frames, said protection clamp being engaged with a middle section of said body and acting as a clicked-on shield.

6. The cover for converting a kitchen knife into a peeler as claimed in claim 5, wherein a locking point is each provided extending from a respective one of said locking panels of said protection clamp.

7. The cover for converting a kitchen knife into a peeler as claimed in claim 5, wherein a ventilation hole is provided close to a tip of said body.
